(19) United States
(12) Patent Application Publication
(10) Pub. No.: US 2014/0207621 A1
(43) Pub. Date: Jul. 24, 2014

(54) SYSTEM FOR MANAGEMENT OF RETAIL AND WHOLESALE WINE INVENTORY AND A CONSUMER TRACKING SYSTEM DERIVED FROM CONSUMER INITIATED DATA

(71) Applicant: Sheila Tendy, New York, NY (US)

(72) Inventor: Sheila Tendy, New York, NY (US)

(21) Appl. No.: 13/748,701

(22) Filed: Jan. 24, 2013

(51) Int. Cl. G06Q 10/08; G06Q 30/06

(52) U.S. Cl. CPC G06Q 10/087; G06Q 30/0625
USPC 705/26.62

(57) ABSTRACT

WineScan is a system of providing a web-based, mobile-enabled wine community for wineries, retailers and consumers. This system uses industry data, consumer preference data and location data stored in a database to provide consumers with personalized location-based wine recommendations. Analysis of the consumer preference data collected provides marketing data back to retailers, wholesalers and vintners.

Wine is an appealing beverage, but drinking it can be intimidating because the industry is complex and dynamic, with multiple varietals ever changing vintages, varying blending methods and expert ratings. For most consumers this is relatively low-involvement purchase, yet purchasing wine can be overwhelming.

There is a need in the marketplace to provide consumers of varying budgets, wine knowledge, and levels of interest with an interactive, on-the-go personalized wine experience to help them share information and provide them with recommendations based upon their tastes and/or location. Plus, an industry need to understand consumer preferences better.

### CROSS-REFERENCE TO RELATED APPLICATIONS

This application is based on prior provisional application, filed on Jan. 25, 2012, application No. 61/590,382 and is claiming prior benefit of that application.

### BACKGROUND OF THE INVENTION

WineScan is a system and method of providing a web-based, mobile-enabled wine community for use by every player in the wine business—from wineries to retailers to consumers. This system uses wine industry data, consumer preference data and location data stored in a database to provide consumers with personalized location-based wine recommendations. Analysis of the consumer preference data collected provides marketing data back to retailers, wholesalers and vintners.

Wine can be a very appealing beverage, drinking it can be intimidating because it is a complex, dynamic industry with multiple varietals ever changing vintages, varying blending methods and expert wine ratings. For most consumers this is relatively low-involvement purchase and the nature of the industry can be overwhelming.

There is a need in the marketplace for a system to provide consumers of varying budgets, wine knowledge, and levels of interest with an interactive, on-the-go personalized wine experience that will aide them in sharing information about wine, provide them with recommendations based upon their tastes and/or location. There is also a need for a system that allows all the players in the wine industry—from the wineries to the consumers—to share information. There is also a need for a system that provides a more effective, low cost marketing channel for smaller producers so as to raise brand awareness and encourage consumers to develop their own wine palate by venturing outside of those mainstream brand names that they purchase because of name recognition. Finally, there is also a need for a system that provides valuable data for the wine industry to evaluate and make strategic decisions. WineScan will be able to meet these needs.

### SUMMARY OF THE INVENTION

WineScan is a method for management of retail and wholesale wine inventory and a consumer wine tracking system. WineScan uses bar code scanning technology in smartphones to capture, store and share information about wine with consumers, retailers, wholesalers and vintners. When a consumer scans a bar code on a wine bottle, WineScan will be able to geo-locate that wine in local restaurants and wine shops and save information about wines on a corresponding website. The information gathered about consumer preferences and purchasing habits will be aggregated and shared across all aspects of the supply chain, from retailers, to wholesalers to vintners.

### BRIEF DESCRIPTION OF DRAWINGS

FIG. 1 is a drawing that demonstrates how a mobile phone scans information, sends it to a server where it is stored and how the information can be retrieved.

FIG. 2 shows how a UPC/EAN label can be scanned by a smartphone.

FIG. 3 shows how the information collected from the scanned UPC label is sent and stored on a server.

FIG. 4 show how the information stored on the server can be retrieved and combined with other related data.

FIG. 5 is a flow chart that demonstrates how up-to-date information from inventory management systems of retailers, wholesalers and vintners is stored on the server and how the server collects information from consumers.

### DETAILED DESCRIPTION OF THE INVENTION

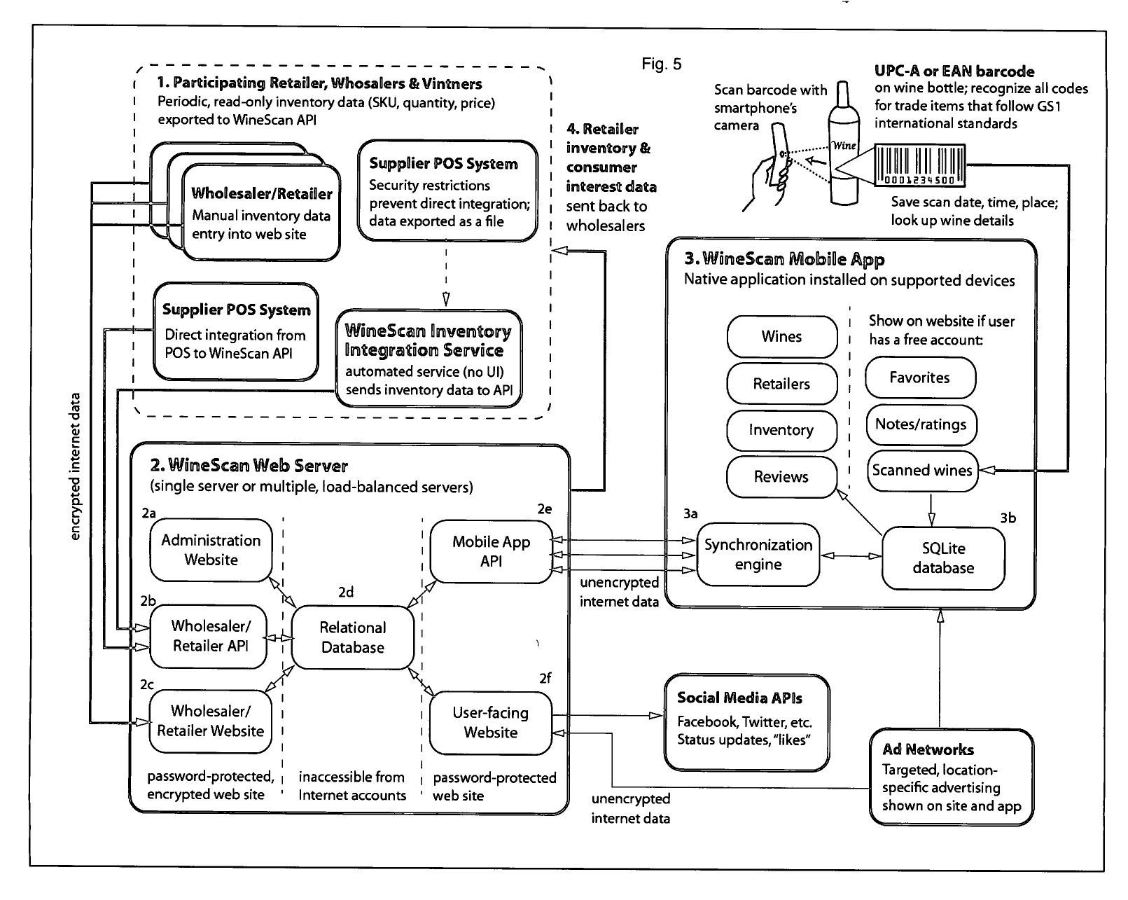

The WineScan technology platform consists of three major components (FIG. 5):

Participating Retailers, Wholesalers and Vintners, who provide inventory data, either directly from their supported POS system or through a manual data export.

A Web server, which contains both private and public-facing web sites and services.

A native smartphone app, available to be installed by the general public on any supported device.

Each of these components exchanges data over the Internet. Retailers, wholesalers and vintners (1) may use a private website (2c) with an encrypted data connection to enter their inventory manually, automatically send reports from their POS system (2b), or may export a file which is imported into the web server without an Internet connection at all by the Inventory Integration Service.

All data is stored on the Web Server in a Relational Database (2d) in normalized, related tables that allows fast searching, sorting, and a consistent method to organize the data.

The main tables are:

Users—All system users, such as End-Users, Retailers and Administrators

Wines—Distinguished by Vintner or Producer, Varietal, Size and Year, and including a Title, Description, and default label or bottle image

Inventories—Lists of Wines and Quantities in-stock per retailer, together with the UPC-A or EAN code (also known as SKU or barcode)

Locations—Actual places which can be plotted on a map, such as wine stores, restaurants, or vineyards, where wine may be purchased or stored.

Favorites—Favorite wines or locations for each User

Scans—A record of each scanned barcode by each User, with date, time, and latitude & longitude where it occurred

Ratings/Notes—A record of notes and ratings for a specific wine, by each User

Reviews—Articles about some of the wines, written either by recognized experts or by WineScan Users

Users download and install the WineScan app on supported smart phones. The Synchronization Engine (3a) periodically requests relevant subsets of the data from the web server's database (2d) over the Internet through the Mobile API (2e) and stores it in a local relational database (3b) on the smart phone. The Synchronization Engine only requests information the User is looking for, which is not already in the local database, eliminating the need to send large amounts of data over the Internet. This saves battery life, keeps data charges low, and allows the app to be used even when there is no Internet connection available. When an app User creates a free account, either on the website or on the phone, the Synchronization engine also periodically sends Favorites, Scans, and Notes/Ratings over the Internet to the Mobile API, which stores them in the web server's database, so they can be viewed on the WineScan User-facing website (2f).

The WineScan app takes a picture, using the smart phone's camera, of a UPC-A or EAN-13 barcode on a bottle of wine. These barcodes are currently the only internationally-recognized codes for trade items, and follow the GS1 standard, and decodes the numerical value in the barcode. The app then finds the associated wine from the inventory in the local database (3b) or the web server's database (2d) and shows the associated details to the User.

The app also shows where a specific wine is located on a map—the Inventory database table has information about which participating retailers have that specific wine in stock, and the Locations table knows where each retailer is located. The GPS chip built into supported smart phones also can show the User's current location on the map, so that only nearby retailers appear.

App Users can also take notes about any wine, save ratings, and mark favorites in the app, which are saved in the smart phone's database and also shown on the WineScan website for registered Users.

Registered Users may include account information from Facebook, Twitter and other social networks, to be able to easily share which wines they are scanning, ratings, favorites, or reviews.

Ads are shown on the website and in the app, and can be targeted to the specific User's demographics, preferences, and current geographic location.

WineScan Administrators periodically add, edit and delete wines, reviews, and retailers in the web server's database through a password-protected Administration Website (2a) which uses SSL encryption for all communication with the Administrator's browser.

Presently, there is not direct electronic communication between the majority of retailers and wholesalers. Nor is there direct electronic communication among vintners, retailers and wholesalers. This system will allow all parts of the wine industry to communicate directly and to automatically inform the inventory system of all industry components.

The consumer driven data will be used to create a tracking system for consumers of the wine they purchase and would like to locate for purchase again. The data will also be used to create an inventory tracking system for the wholesale and retail wine industry globally (4). Participating wholesalers will receive regular, detailed reports of the wines that are sold at participating retailers, and also wines that members are interested in buying in each region.

The system will also allow retailers to directly correlate point of sale inventory data to specific consumer preferences in any one geographic region. This system will drive consumer purchase data automatically “up the chain” through the retail inventory level and allow the retailer to communicate directly and specifically to the wholesaler about inventory needs as well as the producer. This will allow for specific inventory control from the producer to the wholesaler and back to the consumer.

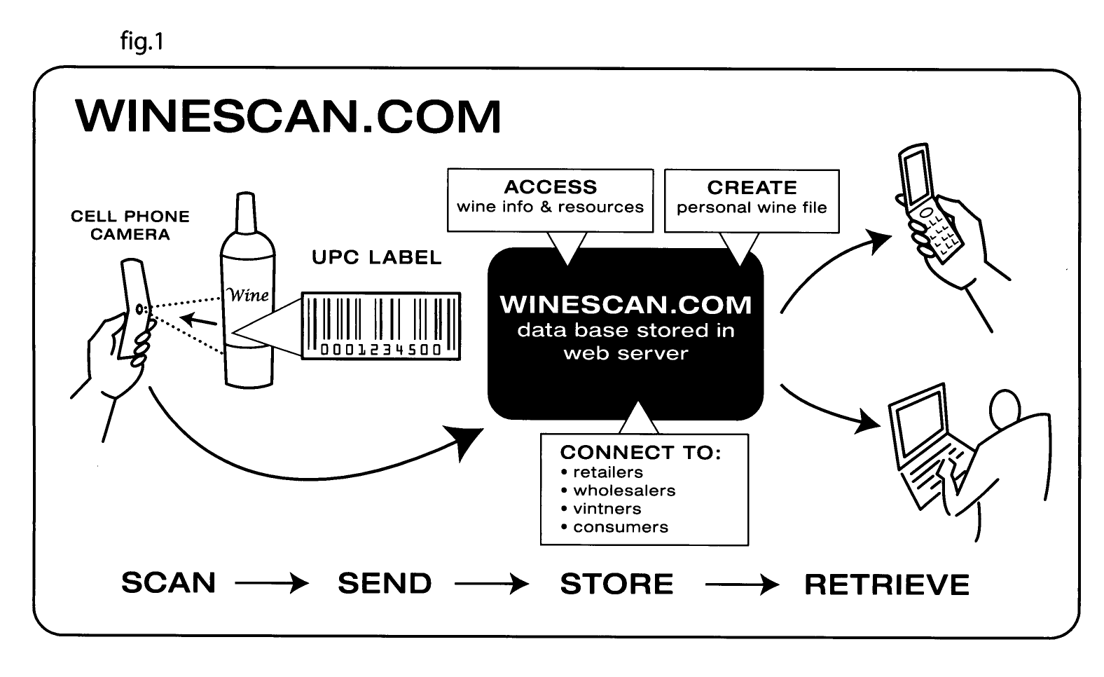

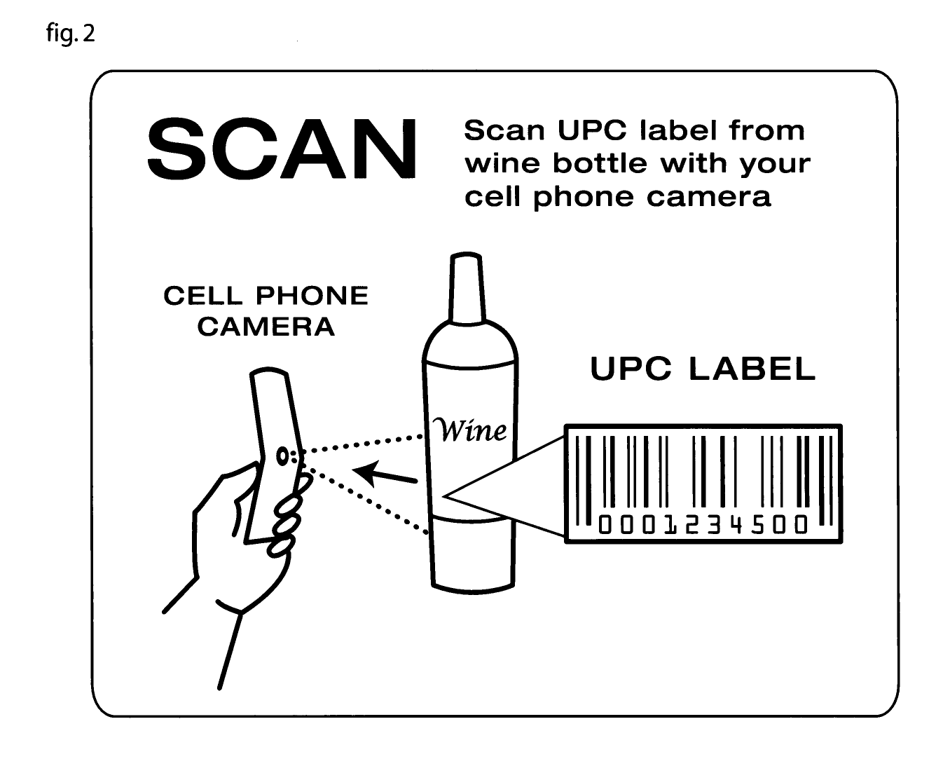

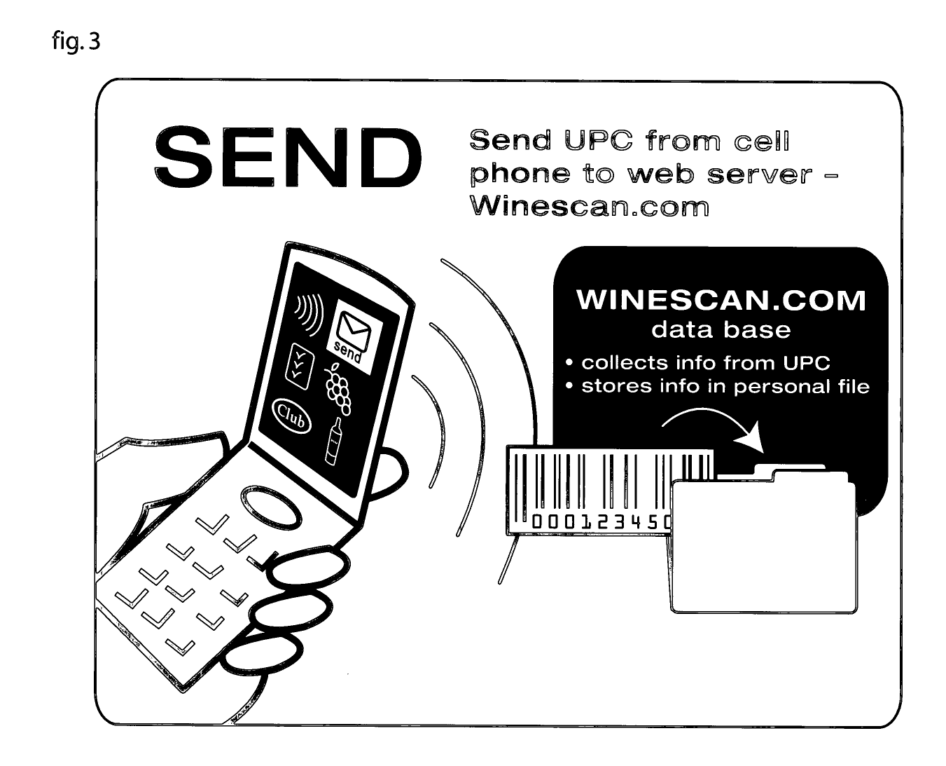

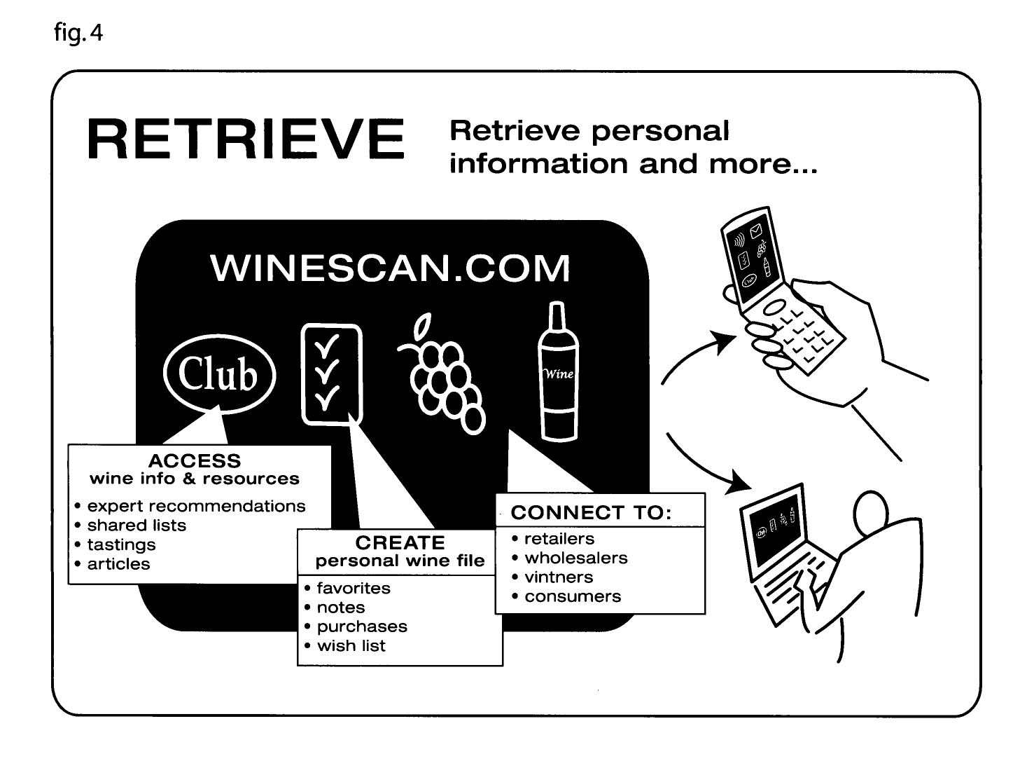

Technology Development (FIGS. 1-4)

The WineScan technology platform is composed of two customer-facing parts:

A smartphone application, with barcode or QR code scanning capability, a database, GPS, and the ability to connect to the Internet wirelessly, and

A website, where much of the same content is available, but on a larger screen, with the ability to search, sort, and change preferences more easily.

Scans of wine labels made on the smartphone are periodically uploaded to the user's account on the website, and choices made on the website are wirelessly downloaded by the smartphone, so that both are kept in sync.

A third component is used to periodically update inventory data from participating retailers, so that end-users are able to find nearby stores or restaurants that have a particular bottle of wine in stock.

System Components

The proposed system is comprised of four high-level components. The following sections describe each in detail. The four components are:

Central Data Component

Mobile Application(s)

Website

Social-Media Integration

Data Component

The core of the system is a central database, hosted on an industry-standard Linux server that has the ability to expand into multiple databases if load-balancing needs require. The database is normalized, to avoid repeated items, and contains the following main tables:

Users—All system users, such as End-Users and Administrators

Wines—Distinguished by Vintner or Producer, Varietal, Size and Year, and including a Title, Description, and default label or bottle image

Inventories—Lists of Wines and Quantities in-stock per retailer, together with the UPC code (also known as SKU or barcode)

Locations—Actual places which can be plotted on a map, such as wine stores, restaurants, vineyards, or even a user's home, where wine may be purchesed or stored.

Several other associated tables are used to maintain relationships between these tables, or provide lookup values, such as types of grapes or regions where wine is produced.

Finally, a table will store a user's wines, with details on when and where they tried or scanned them, ratings, notes, and an optional photo of the label or bottle to supplement the official ones. Generic information for the wine is not stored here, only a reference to an entry in the Wines table.

The service layer around the database itself methods that client software (such a the website and the mobile app) use to query and modify the data. The service layer maintains the validity and referential integrity of the data, and hide the implementation details from client applications.

This Data Component is designed for scalability. While the complete set of Wines is likely number only about a million, large amounts of inventory and user meta-data are likely to present the primary scalability challenges. When necessary, the central database can be split into several, easily handling the volume of data that WineScan is likely to generate.

Mobile Application(s)

The core consumer value of WineScan is the convenience of just-in-time access to their wine history, both for the purpose of querying their past experience data, and cataloging new experiences. This is further reinforced with GPS-enabled devices which allow WineScan to locate nearby retailers who have the wines they want, in stock, right now.

The mobile device market includes several platforms, and custom software must be developed for each platform. However, WineScan does not require multi-platform support to enter the market, and will start with an iPhone app.

Website

While much of WineScan's consumer value is driven by the convenience of mobile applications, there are some tasks that demand a traditional web interface.

For instance, while entering and querying individual wines is easily accomplished on a mobile device, managing/cleaning up a large amount of data, or writing detailed notes is not. The website also provides access to the user's complete history, collections and preferences from any web browser.

Social Media Integrations

The Social Internet is a significant and ever-growing aspect of our culture. For WineScan to prosper, it must interoperate, and not compete, with the dominant social platforms. The power of social networks such as Facebook grow exponentially with size; a significant percentage of the wine-drinking demographic participate in social networks, and/or use social communication tools such as Twitter or FourSquare. Seamless integration with the leading networks will provide users an easy way to share their interest in particular wines, which will in turn bring new users to the WineScan platform—integration with social networks constitutes a powerful, yet inexpensive, marketing channel.

Data Component Technology Platform

The technology platform for the Data Component and website is the ubiquitous LAMP (Linux, Apache, MySQL, PHP) platform, using the more object-oriented Ruby on Rails instead of PHP for the website components.

1. A method for management of retail and wholesale wine inventory and a consumer wine tracking system, the method comprising:
Participating retailers, wholesalers and vintners provide wine inventory data by inputting information from their point of sale system or through a manual data export;
An electronically stored wine inventory database containing unique information about the scanned wine including the vintner or producer, description, year, grape, region, and vineyard; and
Consumers scanning a UPC-A or EAN-13 barcode located on a wine bottle with a smart phone camera.

2. The method of claim 1 further comprising data generated bar codes creating a wine inventory database containing information from wines.

3. The method of claim 2 further comprising electronically storing information regarding the scanned wine for the users (consumers, retailers, wholesalers, vintners, restaurants).

4. The method of claim 1 further comprising a global positioning system (GPS) enabling the user to locate on a plotted map all nearby retailers that sell the scanned wine.

5. The method of claim 1 further comprising:
An inventory tracking system for global wholesalers and retailers; and
Participating wholesalers and retailers receiving electronically detailed reports of wine consumption and sales patters at participating retailers in each region.
Passive marketing channel for retailers, wholesalers, and vintners.
